(19) United States
(12) Patent Application Publication
(10) Pub. No.: US 2018/0134859 A1
(43) Pub. Date: May 17, 2018

(54) SYNTHETIC HIGH POLYMER FILM HAVING SURFACE PROVIDED WITH ANTISEPTIC PROPERTY

(71) Applicant: SHARP KABUSHIKI KAISHA, Sakai City, Osaka (JP)

(72) Inventors: MIHO YAMADA, Sakai City (JP); KIYOSHI MINOURA, Sakai City (JP); TAKAHIRO NAKAHARA, Sakai City (JP); KEN ATSUMO, Sakai City (JP)

(21) Appl. No.: 15/570,236

(22) PCT Filed: Apr. 25, 2016
(86) PCT No.: PCT/JP2016/062920

§ 371 Date: Oct. 27, 2017

(30) Foreign Application Priority Data
Apr. 30, 2015 (JP) 2015-092884

(51) Int. Cl. C08J 5/18

(52) U.S. Cl. CPC C08J 5/18; C08J 2433/14; C08J 2333/14

(57) ABSTRACT

A synthetic polymer film (34A), (34B) having a surface which has a plurality of raised portions (34Ap), (34Bp), wherein a two-dimensional size of the plurality of raised portions (34Ap), (34Bp) is in a range of more than 20 nm and less than 500 nm when viewed in a normal direction of the synthetic polymer film (34A), (34B), the surface having a microbicidal effect, and a zeta potential at the surface is not more than -46.3 mV.

### TECHNICAL FIELD

The present invention relates to a synthetic polymer film whose surface has a microbicidal activity, a sterilization method with the use of the surface of the synthetic polymer film, a mold for production of the synthetic polymer film, and a mold manufacturing method. In this specification, the “mold” includes molds that are for use in various processing methods (stamping and casting), and is sometimes referred to as a stamper. The “mold” can also be used for printing (including nanoimprinting).

### BACKGROUND ART

Recently, it was reported that surficial nanostructures of black silicon, wings of cicadas and dragonflies have a bactericidal activity (Non-patent Document 1). Reportedly, the physical structure of the nanopillars that black silicon and wings of cicadas and dragonflies have produces a bactericidal activity.

According to Non-patent Document 1, black silicon has the strongest bactericidal activity on Gram-negative bacteria, while wings of dragonflies have a weaker bactericidal activity, and wings of cicadas have a still weaker bactericidal activity. Black silicon has 500 nm tall nanopillars. Wings of cicadas and dragonflies have 240 nm tall nanopillars. The static contact angle (hereinafter, sometimes simply referred to as “contact angle”) of the black silicon surface with respect to water is 80°, while the contact angles of the surface of wings of dragonflies and cicadas with respect to water are 153° and 159°, respectively. It is estimated that black silicon is mainly made of silicon, and wings of dragonflies and cicadas are made of chitin. According to Non-patent Document 1, the composition of the surface of black silicon is generally a silicon oxide, and the composition of the surface of wings of dragonflies and cicadas is generally a lipid.

### CITATION LIST

### Patent Literature

Patent Document 1: Japanese Patent No. 4265729

Patent Document 2: Japanese Laid-Open Patent Publication No. 2009-166502

Patent Document 3: WO 2011/125486

Patent Document 4: WO 2013/183576

### Non-Patent Literature

Non-patent Document 1: Ivanova, E. P. et al., “Bactericidal activity of black silicon”, Nat. Commun. 4:2838 doi: 10.1038/ncomms3838 (2013).

### SUMMARY OF INVENTION

### Technical Problem

The mechanism of killing bacteria by nanopillars is not clear from the results described in Non-patent Document 1. It is also not clear whether the reason why black silicon has a stronger bactericidal activity than wings of dragonflies and cicadas resides in the difference in height or shape of nanopillars, in the difference in surface free energy (which can be evaluated by the contact angle), in the materials that constitute nanopillars, or in the chemical properties of the surface.

The bactericidal activity of black silicon is difficult to utilize because black silicon is poor in mass productivity, and is hard but brittle so that the shapability is poor.

The present invention was conceived for the purpose of solving the above problems. The major objects of the present invention include providing a synthetic polymer film whose surface has a microbicidal activity, a sterilization method with the use of the surface of the synthetic polymer film, a mold for production of the synthetic polymer film, and a mold manufacturing method.

### Solution to Problem

A synthetic polymer film of an embodiment of the present invention is a synthetic polymer film having a surface which has a plurality of raised portions, wherein a two-dimensional size of the plurality of raised portions is in a range of more than 20 nm and less than 500 nm when viewed in a normal direction of the synthetic polymer film, the surface having a microbicidal effect, and a zeta potential at the surface is not more than −46.3 mV. The zeta potential at the surface may be not more than −48.8 mV.

In one embodiment, the synthetic polymer film contains a nitrogen element. The concentration of the nitrogen element at the surface is preferably not less than 0.7 at %.

### Advantageous Effects of Invention

According to an embodiment of the present invention, a synthetic polymer film whose surface has a microbicidal activity, a sterilization method with the use of the surface of the synthetic polymer film, a mold for production of the synthetic polymer film, and a mold manufacturing method are provided.

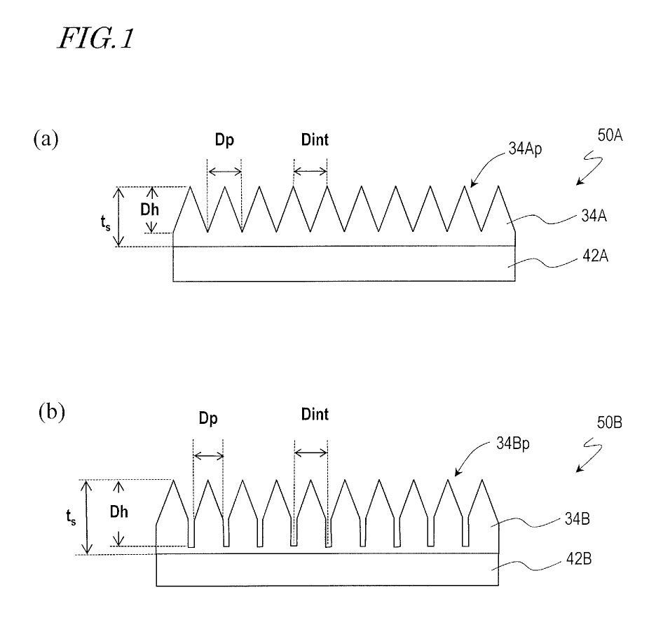

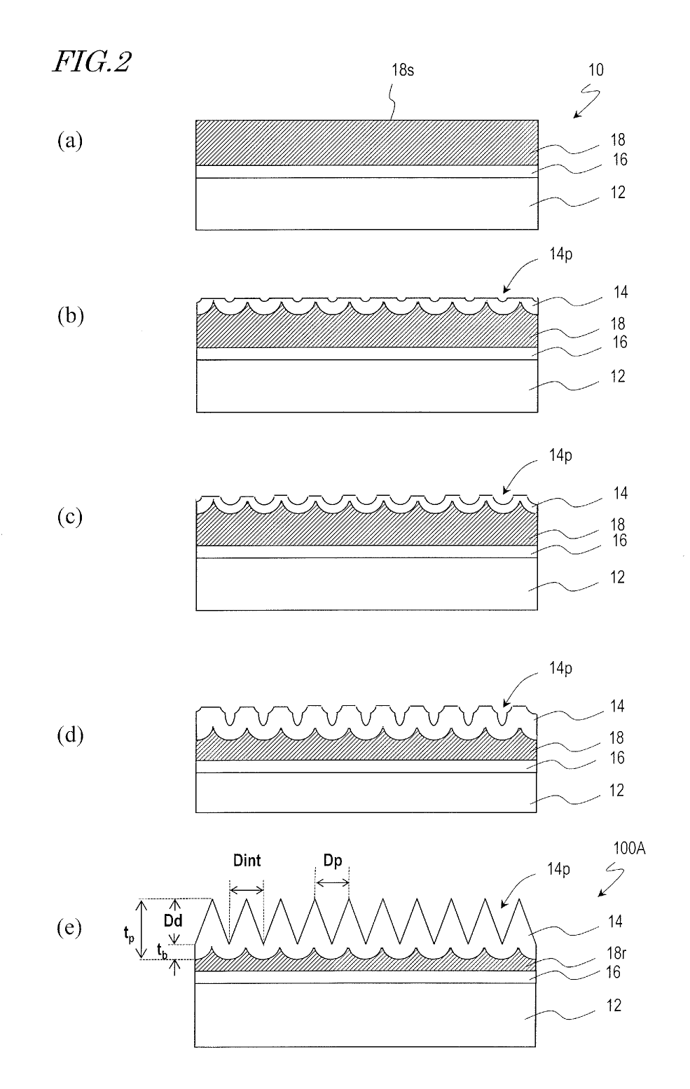

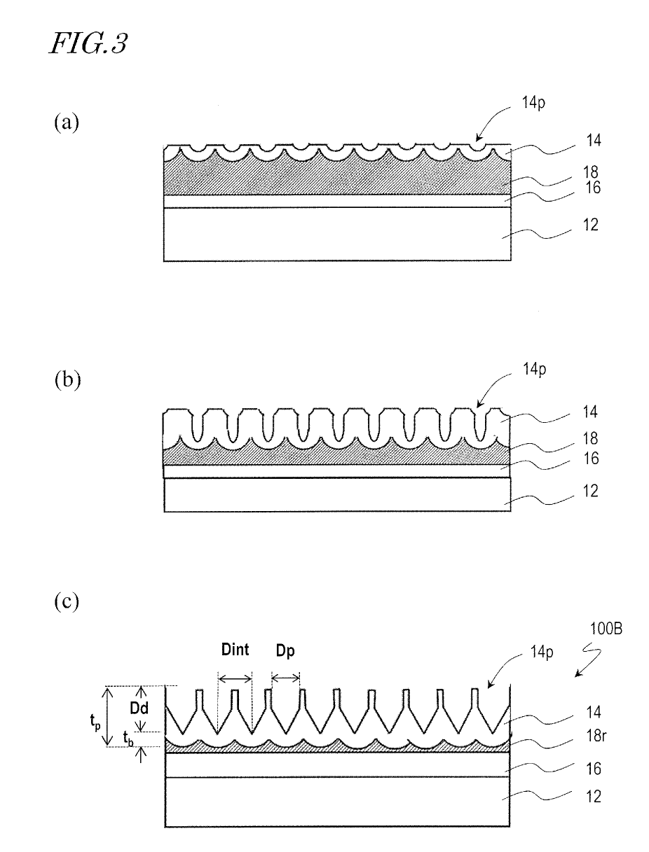

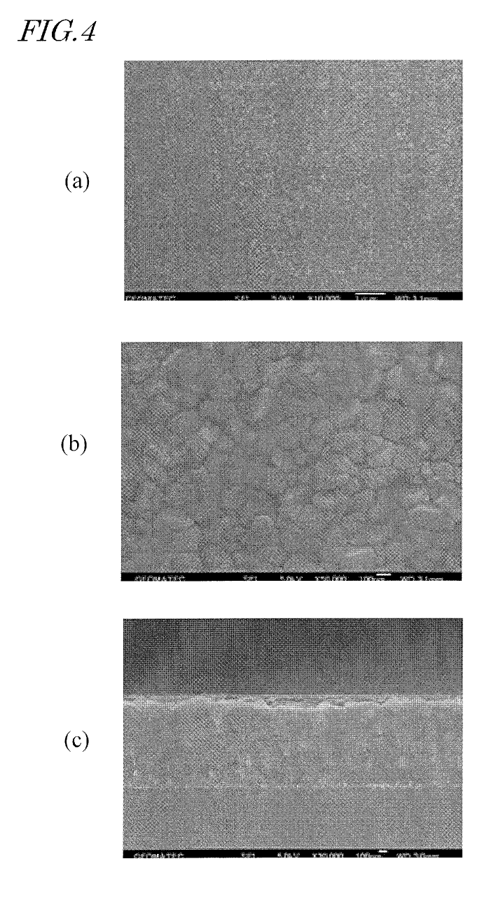

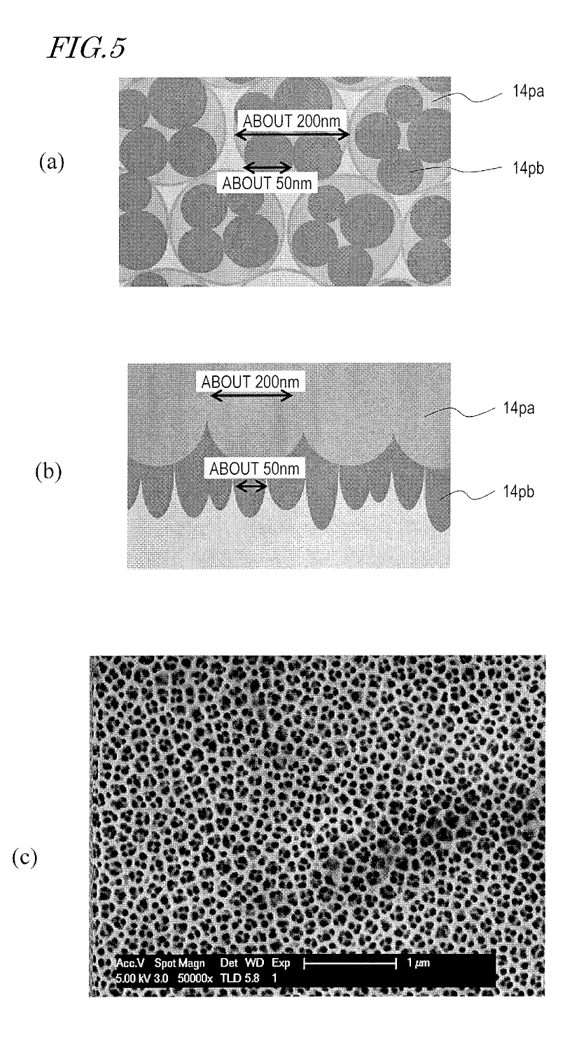

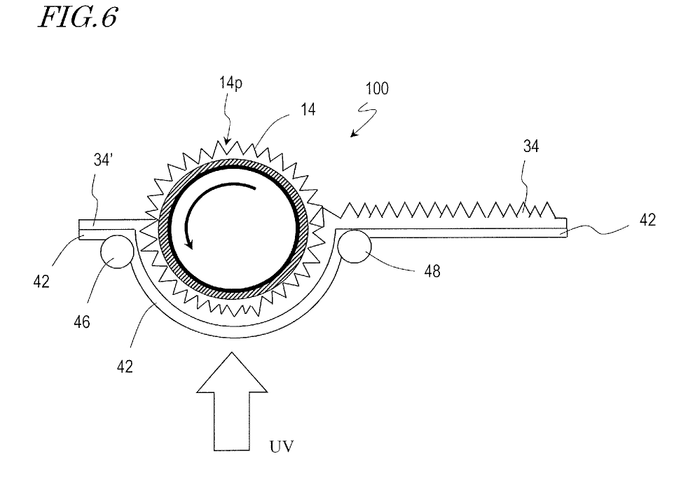

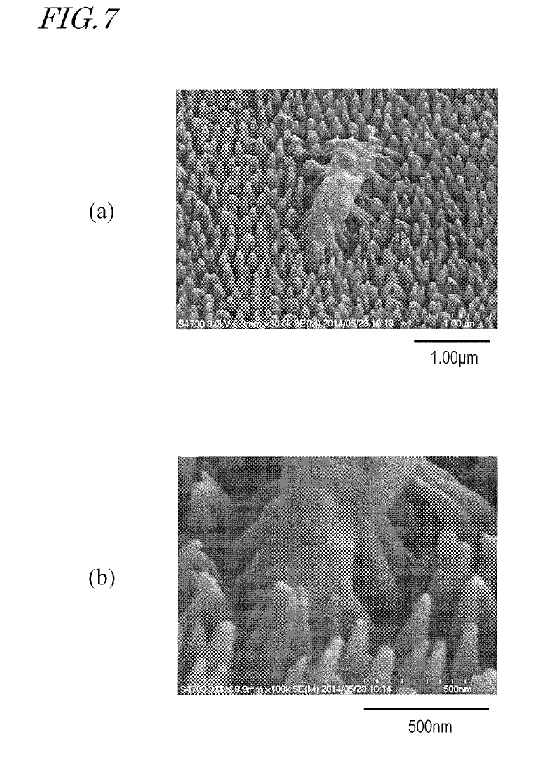

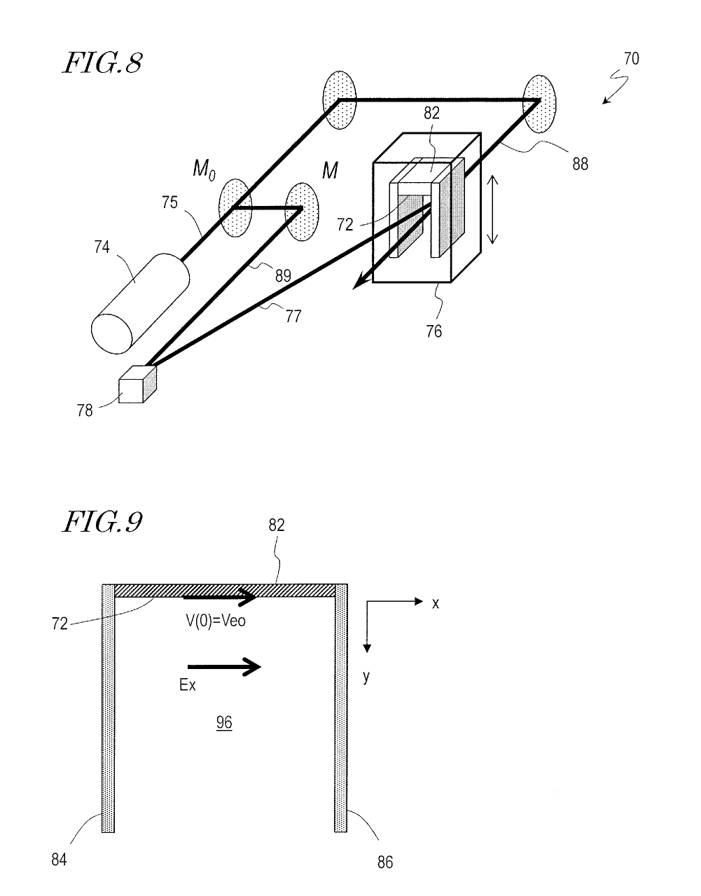

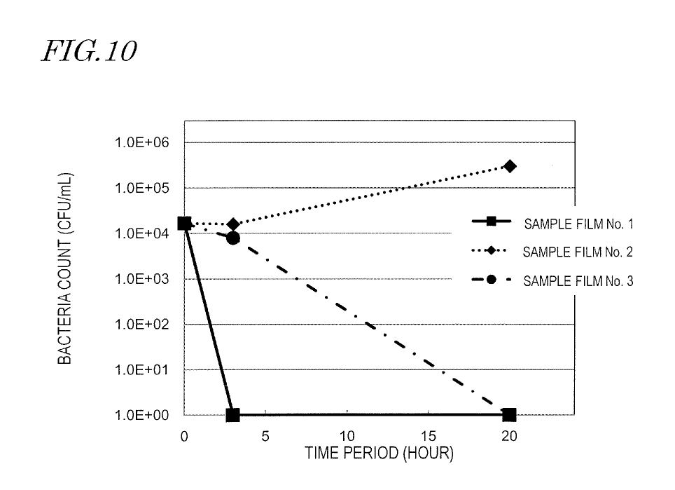

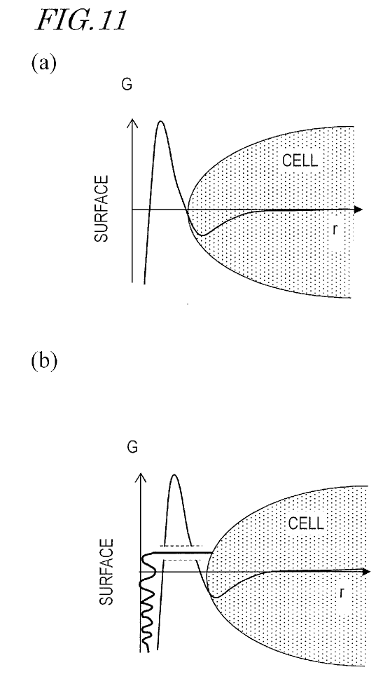

### BRIEF DESCRIPTION OF DRAWINGS

[FIG. 1](a) and (b) are schematic cross-sectional views of synthetic polymer films 34A and 34B, respectively, according to embodiments of the present invention.

[FIG. 2](a) to (e) are diagrams for illustrating a method for manufacturing a moth-eye mold 100A and a configuration of the moth-eye mold 100A.

[FIG. 3](a) to (c) are diagrams for illustrating a method for manufacturing a moth-eye mold 100B and a configuration of the moth-eye mold 100B.

[FIG. 4](a) shows a SEM image of a surface of an aluminum base. (b) shows a SEM image of a surface of an aluminum film. (c) shows a SEM image of a cross section of the aluminum film.

[FIG. 5](a) is a schematic plan view of a porous alumina layer of a mold. (b) is a schematic cross-sectional view of the porous alumina layer. (c) is a SEM image of a prototype mold.

[FIG. 6] A diagram for illustrating a method for producing a synthetic polymer film with the use of the moth-eye mold 100.

[FIG. 7](a) and (b) show SEM images obtained by SEM (Scanning Electron Microscope) observation of a P. aeruginosa bacterium which died at a surface which had a moth-eye structure.

[FIG. 8] A schematic diagram showing the entire configuration of a zeta potential measuring system 70.

[FIG. 9] A schematic diagram for illustrating the flow mechanism of tracer particles at a surface 72 of a sample 82.

[FIG. 10] A graph showing the evaluation results as to the microbicidal ability.

[FIG. 11] Schematic diagrams for illustrating a two-phase adhesion mechanism of microorganisms. (a) shows the first phase (reversible adhesion phase). (b) shows the second phase (irreversible adhesion phase).

### DESCRIPTION OF EMBODIMENTS

Hereinafter, a synthetic polymer film whose surface has a microbicidal effect, a sterilization method with the use of the surface of the synthetic polymer film, a mold for production of the synthetic polymer film, and a mold manufacturing method according to embodiments of the present invention are described with reference to the drawings.

In this specification, the following terms are used.

“Sterilization” (or “microbicidal”) means reducing the number of proliferative microorganisms contained in an object, such as solid or liquid, or a limited space, by an effective number.

“Microorganism” includes viruses, bacteria, and fungi.

“Antimicrobial” generally includes suppressing and preventing multiplication of microorganisms and includes suppressing dinginess and slime which are attributed to microorganisms.

The present applicant conceived a method for producing an antireflection film (an antireflection surface) which has a moth-eye structure with the use of an anodized porous alumina layer. Using the anodized porous alumina layer enables manufacture of a mold which has an inverted moth-eye structure with high mass-productivity (e.g., Patent Documents 1 to 4). The entire disclosures of Patent Documents 1 to 4 are incorporated by reference in this specification.

The present inventors developed the above-described technology and arrived at the concept of a synthetic polymer film whose surface has a microbicidal effect.

The configuration of a synthetic polymer film according to an embodiment of the present invention is described with reference to FIGS. 1(a) and 1(b).

FIGS. 1(a) and 1(b) respectively show schematic cross-sectional views of synthetic polymer films 34A and 34B according to embodiments of the present invention. The synthetic polymer films 34A and 34B described herein as examples are formed on base films 42A and 42B, respectively, although the present invention is not limited to these examples. The synthetic polymer films 34A and 34B can be directly formed on a surface of an arbitrary object.

A film 50A shown in FIG. 1(a) includes a base film 42A and a synthetic polymer film 34A provided on the base film 42A. The synthetic polymer film 34A has a plurality of raised portions 34Ap over its surface. The plurality of raised portions 34Ap constitute a moth-eye structure. When viewed in a normal direction of the synthetic polymer film 34A, the two-dimensional size of the raised portions 34Ap, Dₚ, is in the range of more than 20 nm and less than 500 nm. Here, the “two-dimensional size” of the raised portions 34Ap refers to the diameter of a circle equivalent to the area of the raised portions 34Ap when viewed in a normal direction of the surface. When the raised portions 34Ap have a conical shape, for example, the two-dimensional size of the raised portions 34Ap is equivalent to the diameter of the base of the cone. The typical adjoining distance of the raised portions 34Ap, Dᵢₙₜ, is more than 20 nm and not more than 1000 nm. When the raised portions 34Ap are densely arranged so that there is no gap between adjoining raised portions 34Ap (e.g., the bases of the cones partially overlap each other) as shown in FIG. 1(a), the two-dimensional size of the raised portions 34Ap, Dₚ, is equal to the adjoining distance The typical height of the raised portions 34Ap, Dₕ, is not less than 50 nm and less than 500 nm. As will be described later, a microbicidal activity is exhibited even when the height Dₕ of the raised portions 34Ap is not more than 150 nm. The thickness of the synthetic polymer film 34A, tₛ, is not particularly limited but only needs to be greater than the height Dₕ of the raised portions 34Ap.

The synthetic polymer film 34A shown in FIG. 1(a) has the same moth-eye structure as the antireflection films disclosed in Patent Documents 1 to 4. From the viewpoint of producing an antireflection function, it is preferred that the surface has no flat portion, and the raised portions 34Ap are densely arranged over the surface. Further, the raised portions 34Ap preferably has a such shape that the cross-sectional area (a cross section parallel to a plane which is orthogonal to an incoming light ray, e.g., a cross section parallel to the surface of the base film 42A) increases from the air side to the base film 42A side, e.g., a conical shape. From the viewpoint of suppressing interference of light, it is preferred that the raised portions 34Ap are arranged without regularity, preferably randomly. However, these features are unnecessary when only the microbicidal activity of the synthetic polymer film 34A is pursued. For example, the raised portions 34Ap do not need to be densely arranged. The raised portions 34Ap may be regularly arranged. Note that, however, the shape and arrangement of the raised portions 34Ap are preferably selected such that the raised portions 34Ap effectively act on microorganisms.

A film 50B shown in FIG. 1(b) includes a base film 42B and a synthetic polymer film 34B provided on the base film 42B. The synthetic polymer film 34B has a plurality of raised portions 34Bp over its surface. The plurality of raised portions 34Bp constitute a moth-eye structure. In the film 50B, the configuration of the raised portions 34Bp of the synthetic polymer film 34B is different from that of the raised portions 34Ap of the synthetic polymer film 34A of the film 50A. Descriptions of features which are common with those of the film 50A are sometimes omitted.

When viewed in a normal direction of the synthetic polymer film 34B, the two-dimensional size of the raised portions 34Bp, Dₚ, is in the range of more than 20 nm and less than 500 nm. The typical adjoining distance of the raised portions 34Bp, Dᵢₙₜ, is more than 20 nm and not more than 1000 nm, and Dₚ<Dᵢₙₜ holds. That is, in the synthetic polymer film 34B, there is a flat portion between adjoining raised portions 34Bp. The raised portions 34Bp have the shape of a cylinder with a conical portion on the air side. The typical height of the raised portions 34Bp, Dₕ, is not less than 50 nm and less than 500 nm. The raised portions 34Bp may be arranged regularly or may be arranged irregularly. When the raised portions 34Bp are arranged regularly, Dᵢₙₜ also represents the period of the arrangement. This also applies to the synthetic polymer film 34A, as a matter of course.

In this specification, the “moth-eye structure” includes not only surficial nanostructures that have an excellent antireflection function and that are formed by raised portions which have such a shape that the cross-sectional area (a cross section parallel to the film surface) increases as do the raised portions 34Ap of the synthetic polymer film 34A shown in FIG. 1(a) but also surficial nanostructures that are formed by raised portions which have a part where the cross-sectional area (a cross section parallel to the film surface) is constant as do the raised portions 34Bp of the synthetic polymer film 34B shown in FIG. 1(b). Note that, from the viewpoint of breaking the cell walls and/or cell membranes of microorganisms, providing a conical portion is preferred. Note that, however, the tip end of the conical shape does not necessarily need to be a surficial nanostructure but may have a rounded portion (about 60 nm) which is generally equal to the nanopillars which form surficial nanostructures of the wings of cicadas.

A mold for forming the moth-eye structure such as illustrated in FIGS. 1(a) and 1(b) over the surface (hereinafter, referred to as “moth-eye mold”) has an inverted moth-eye structure obtained by inverting the moth-eye structure. Using an anodized porous alumina layer which has the inverted moth-eye structure as a mold without any modification enables inexpensive production of the moth-eye structure. Particularly when a moth-eye mold in the shape of a hollow cylinder is used, the moth-eye structure can be efficiently manufactured according to a roll-to-roll method. Such a moth-eye mold can be manufactured according to methods disclosed in Patent Documents 2 to 4.

A manufacturing method of a moth-eye mold 100A that is for production of the synthetic polymer film 34A is described with reference to FIGS. 2(a) to 2(e).

Firstly, a mold base 10 is provided which includes an aluminum base 12, an inorganic material layer 16 provided on a surface of the aluminum base 12, and an aluminum film 18 deposited on the inorganic material layer 16 as shown in FIG. 2(a).

The aluminum base 12 used may be an aluminum base whose aluminum purity is not less than 99.50 mass % and less than 99.99 mass % and which has relatively high rigidity. The impurity contained in the aluminum base 12 may preferably include at least one element selected from the group consisting of iron (Fe), silicon (Si), copper (Cu), manganese (Mn), zinc (Zn), nickel (Ni), titanium (Ti), lead (Pb), tin (Sn) and magnesium (Mg). Particularly, Mg is preferred. Since the mechanism of formation of pits (hollows) in the etching step is a local cell reaction, the aluminum base 12 ideally does not contain any element which is nobler than aluminum. It is preferred that the aluminum base 12 used contains, as the impurity element, Mg (standard electrode potential: −2.36 V) which is a base metal. If the content of an element nobler than aluminum is 10 ppm or less, it can be said in terms of electrochemistry that the aluminum base 12 does not substantially contain the element. The Mg content is preferably 0.1 mass % or more of the whole. It is, more preferably, in the range of not more than about 3.0 mass %. If the Mg content is less than 0.1 mass %, sufficient rigidity cannot be obtained. On the other hand, as the Mg content increases, segregation of Mg is more likely to occur. Even if the segregation occurs near a surface over which a moth-eye mold is to be formed, it would not be detrimental in terms of electrochemistry but would be a cause of a defect because Mg forms an anodized film of a different form from that of aluminum. The content of the impurity element may be appropriately determined depending on the shape, thickness, and size of the aluminum base 12, in view of required rigidity. For example, when the aluminum base 12 in the form of a plate is prepared by rolling, the appropriate Mg content is about 3.0 mass %. When the aluminum base 12 having a three-dimensional structure of, for example, a hollow cylinder is prepared by extrusion, the Mg content is preferably 2.0 mass % or less. If the Mg content exceeds 2.0 mass %, the extrudability deteriorates in general.

The aluminum base 12 used may be an aluminum pipe in the shape of a hollow cylinder which is made of, for example, JIS A1050, an Al—Mg based alloy (e.g., JIS A5052), or an Al—Mg—Si based alloy (e.g., JIS A6063).

The surface of the aluminum base 12 is preferably a surface cut with a bit. If, for example, abrasive particles are remaining on the surface of the aluminum base 12, conduction will readily occur between the aluminum film 18 and the aluminum base 12 in a portion in which the abrasive particles are present. Not only in the portion in which the abrasive particles are remaining but also in a portion which has a roughened surface, conduction readily occurs between the aluminum film 18 and the aluminum base 12. When conduction occurs locally between the aluminum film 18 and the aluminum base 12, there is a probability that a local cell reaction will occur between an impurity in the aluminum base 12 and the aluminum film 18.

The material of the inorganic material layer 16 may be, for example, tantalum oxide (Ta₂O₅) or silicon dioxide (SiO₂). The inorganic material layer 16 can be formed by, for example, sputtering. When a tantalum oxide layer is used as the inorganic material layer 16, the thickness of the tantalum oxide layer is, for example, 200 nm.

The thickness of the inorganic material layer 16 is preferably not less than 100 nm and less than 500 nm. If the thickness of the inorganic material layer 16 is less than 100 nm, there is a probability that a defect (typically, a void; i.e., a gap between crystal grains) occurs in the aluminum film 18. If the thickness of the inorganic material layer 16 is not less than 500 nm, insulation is likely to occur between the aluminum base 12 and the aluminum film 18 due to the surface condition of the aluminum base 12. To realize anodization of the aluminum film 18 by supplying an electric current from the aluminum base 12 side to the aluminum film 18, the electric current needs to flow between the aluminum base 12 and the aluminum film 18. When employing a configuration where an electric current is supplied from the inside surface of the aluminum base 12 in the shape of a hollow cylinder, it is not necessary to provide an electrode to the aluminum film 18. Therefore, the aluminum film 18 can be anodized across the entire surface, while such a problem does not occur that supply of the electric current becomes more difficult as the anodization advances. Thus, the aluminum film 18 can be anodized uniformly across the entire surface.

To form a thick inorganic material layer 16, it is in general necessary to increase the film formation duration. When the film formation duration is increased, the surface temperature of the aluminum base 12 unnecessarily increases, and as a result, the film quality of the aluminum film 18 deteriorates, and a defect (typically, a void) occurs in some cases. When the thickness of the inorganic material layer 16 is less than 500 nm, occurrence of such a problem can be suppressed.

The aluminum film 18 is, for example, a film which is made of aluminum whose purity is not less than 99.99 mass % (hereinafter, sometimes referred to as “high-purity aluminum film”) as disclosed in Patent Document 3. The aluminum film is formed by, for example, vacuum evaporation or sputtering. The thickness of the aluminum film 18 is preferably in the range of not less than about 500 nm and not more than about 1500 nm. For example, the thickness of the aluminum film 18 is about 1 μm.

The aluminum film 18 may be an aluminum alloy film disclosed in Patent Document 4 in substitution for the high-purity aluminum film. The aluminum alloy film disclosed in Patent Document 4 contains aluminum, a metal element other than aluminum, and nitrogen. In this specification, the “aluminum film” includes not only the high-purity aluminum film but also the aluminum alloy film disclosed in Patent Document 4.

Using the above-described aluminum alloy film enables to obtain a specular surface whose reflectance is not less than 80%. The average grain diameter of crystal grains that form the aluminum alloy film when viewed in the normal direction of the aluminum alloy film is, for example, not more than 100 nm, and that the maximum surface roughness Rmax of the aluminum alloy film is not more than 60 nm. The content of nitrogen in the aluminum alloy film is, for example, not less than 0.5 mass % and not more than 5.7 mass %. It is preferred that the absolute value of the difference between the standard electrode potential of the metal element other than aluminum which is contained in the aluminum alloy film and the standard electrode potential of aluminum is not more than 0.64 V, and that the content of the metal element in the aluminum alloy film is not less than 1.0 mass % and not more than 1.9 mass %. The metal element is, for example, Ti or Nd. The metal element is not limited to these examples but may be such a different metal element that the absolute value of the difference between the standard electrode potential of the metal element and the standard electrode potential of aluminum is not more than 0.64 V (for example, Mn, Mg, Zr, V, and Pb). Further, the metal element may be Mo, Nb, or Hf. The aluminum alloy film may contain two or more of these metal elements. The aluminum alloy film is formed by, for example, a DC magnetron sputtering method. The thickness of the aluminum alloy film is also preferably in the range of not less than about 500 nm and not more than about 1500 nm. For example, the thickness of the aluminum alloy film is about 1 μm.

Then, a surface 18s of the aluminum film 18 is anodized to form a porous alumina layer 14 which has a plurality of recessed portions (micropores) 14p as shown in FIG. 2(b). The porous alumina layer 14 includes a porous layer which has the recessed portions 14p and a barrier layer (the base of the recessed portions (micropores) 14p). As known in the art, the interval between adjacent recessed portions 14p (the distance between the centers) is approximately twice the thickness of the barrier layer and is approximately proportional to the voltage that is applied during the anodization. This relationship also applies to the final porous alumina layer 14 shown in FIG. 2(e).

The porous alumina layer 14 is formed by, for example, anodizing the surface 18s in an acidic electrolytic solution. The electrolytic solution used in the step of forming the porous alumina layer 14 is, for example, an aqueous solution which contains an acid selected from the group consisting of oxalic acid, tartaric acid, phosphoric acid, sulfuric acid, chromic acid, citric acid, and malic acid. For example, the surface 18s of the aluminum film 18 is anodized with an applied voltage of 80 V for 55 seconds using an oxalic acid aqueous solution (concentration: 0.3 mass %, solution temperature: 10° C.), whereby the porous alumina layer 14 is formed.

Then, the porous alumina layer 14 is brought into contact with an alumina etchant such that a predetermined amount is etched away, whereby the opening of the recessed portions 14p is enlarged as shown in FIG. 2(c). By modifying the type and concentration of the etching solution and the etching duration, the etching amount (i.e., the size and depth of the recessed portions 14p) can be controlled. The etching solution used may be, for example, an aqueous solution of 10 mass % phosphoric acid, organic acid such as formic acid, acetic acid or citric acid, or sulfuric acid, or a chromic/phosphoric acid solution. For example, the etching is performed for 20 minutes using a phosphoric acid aqueous solution (10 mass %, 30° C.)

Then, the aluminum film 18 is again partially anodized such that the recessed portions 14p are grown in the depth direction and the thickness of the porous alumina layer 14 is increased as shown in FIG. 2(d). Here, the growth of the recessed portions 14p starts at the bottoms of the previously-formed recessed portions 14p, and accordingly, the lateral surfaces of the recessed portions 14p have stepped shapes.

Thereafter, when necessary, the porous alumina layer 14 may be brought into contact with an alumina etchant to be further etched such that the pore diameter of the recessed portions 14p is further increased. The etching solution used in this step may preferably be the above-described etching solution. Practically, the same etching bath may be used.

In this way, by alternately repeating the anodization step and the etching step as described above through multiple cycles (e.g., 5 cycles: including 5 anodization cycles and 4 etching cycles), the moth-eye mold 100A that includes the porous alumina layer 14 which has the inverted moth-eye structure is obtained as shown in FIG. 2(e). Since the process is ended with the anodization step, the recessed portions 14p have pointed bottom portion. That is, the resultant mold enables formation of raised portions with pointed tip ends.

The porous alumina layer 14 (thickness: tₚ) shown in FIG. 2(e) includes a porous layer (whose thickness is equivalent to the depth D_{d} of the recessed portions 14p) and a barrier layer (thickness: t_{b}). Since the porous alumina layer 14 has a structure obtained by inverting the moth-eye structure of the synthetic polymer film 34A, corresponding parameters which define the dimensions may sometimes be designated by the same symbols.

The recessed portions 14p of the porous alumina layer 14 may have, for example, a conical shape and may have a stepped lateral surface. It is preferred that the two-dimensional size of the recessed portions 14p (the diameter of a circle equivalent to the area of the recessed portions 14p when viewed in a normal direction of the surface), Dₚ, is more than 20 nm and less than 500 nm, and the depth of the recessed portions 14p, D_{d}, is not less than 50 nm and less than 1000 nm (1 μm). It is also preferred that the bottom portion of the recessed portions 14p is acute (with the deepest part of the bottom portion being pointed). When the recessed portions 14p are in a densely packed arrangement, assuming that the shape of the recessed portions 14p when viewed in a normal direction of the porous alumina layer 14 is a circle, adjacent circles overlap each other, and a saddle portion is formed between adjacent ones of the recessed portions 14p. Note that, when the generally-conical recessed portions 14p adjoin one another so as to form saddle portions, the two-dimensional size of the recessed portions 14p, Dₚ, is equal to the adjoining distance Dᵢₙₜ. The thickness of the porous alumina layer 14, tₚ, is not more than about 1 μm.

Under the porous alumina layer 14 shown in FIG. 2(e), there is an aluminum remnant layer 18r. The aluminum remnant layer 18r is part of the aluminum film 18 which has not been anodized. When necessary, the aluminum film 18 may be substantially thoroughly anodized such that the aluminum remnant layer 18r is not present. For example, when the inorganic material layer 16 has a small thickness, it is possible to readily supply an electric current from the aluminum base 12 side.

The manufacturing method of the moth-eye mold illustrated herein enables manufacture of a mold which is for production of antireflection films disclosed in Patent Documents 2 to 4. Since an antireflection film used in a high-definition display panel is required to have high uniformity, selection of the material of the aluminum base, specular working of the aluminum base, and control of the purity and components of the aluminum film are preferably carried out as described above. However, the above-described mold manufacturing method can be simplified because the microbicidal activity can be achieved without high uniformity. For example, the surface of the aluminum base may be directly anodized. Even if, in this case, pits are formed due to impurities contained in the aluminum base, only local structural irregularities occur in the moth-eye structure of the finally-obtained synthetic polymer film 34A, and it is estimated that there is little adverse influence on the microbicidal activity.

According to the above-described mold manufacturing method, a mold in which the regularity of the arrangement of the recessed portions is low, and which is suitable to production of an antireflection film, can be manufactured. In the case of utilizing the microbicidal ability of the moth-eye structure, it is estimated that the regularity of the arrangement of the raised portions does not exert an influence. A mold for formation of a moth-eye structure which has regularly-arranged raised portions can be manufactured, for example, as described in the following section.

For example, after formation of a porous alumina layer having a thickness of about 10 μm, the formed porous alumina layer is removed by etching, and then, anodization may be performed under the conditions for formation of the above-described porous alumina layer. A 10 μm thick porous alumina layer is realized by extending the anodization duration. When such a relatively thick porous alumina layer is formed and then this porous alumina layer is removed, a porous alumina layer having regularly-arranged recessed portions can be formed without being influenced by irregularities which are attributed to grains that are present at the surface of an aluminum film or aluminum base or the process strain. Note that, in removal of the porous alumina layer, using a chromic/phosphoric acid solution is preferred. Although continuing the etching for a long period of time sometimes causes galvanic corrosion, the chromic/phosphoric acid solution has the effect of suppressing galvanic corrosion.

A moth-eye mold for production of the synthetic polymer film 34B shown in FIG. 1(b) can be, basically, manufactured by combination of the above-described anodization step and etching step. A manufacturing method of a moth-eye mold 100B that is for production of the synthetic polymer film 34B is described with reference to FIGS. 3(a) to 3(c).

Firstly, in the same way as illustrated with reference to FIGS. 2(a) and 2(b), the mold base 10 is provided, and the surface 18s of the aluminum film 18 is anodized, whereby a porous alumina layer 14 which has a plurality of recessed portions (micropores) 14p is formed.

Then, the porous alumina layer 14 is brought into contact with an alumina etchant such that a predetermined amount is etched away, whereby the opening of the recessed portions 14p is enlarged as shown in FIG. 3(a). In this step, the etched amount is smaller than in the etching step illustrated with reference to FIG. 2(c). That is, the size of the opening of the recessed portions 14p is decreased. For example, the etching is performed for 10 minutes using a phosphoric acid aqueous solution (10 mass %, 30° C.)

Then, the aluminum film 18 is again partially anodized such that the recessed portions 14p are grown in the depth direction and the thickness of the porous alumina layer is increased as shown in FIG. 3(b). In this step, the recessed portions 14p are grown deeper than in the anodization step illustrated with reference to FIG. 2(d). For example, the anodization is carried out with an applied voltage of 80 V for 165 seconds (in FIG. 2(d), 55 seconds) using an oxalic acid aqueous solution (concentration: 0.3 mass %, solution temperature: 10° C.)

Thereafter, the etching step and the anodization step are alternately repeated through multiple cycles in the same way as illustrated with reference to FIG. 2(e). For example, 3 cycles of the etching step and 3 cycles of the anodization step are alternately repeated, whereby the moth-eye mold 100B including the porous alumina layer 14 which has the inverted moth-eye structure is obtained as shown in FIG. 3(c). In this step, the two-dimensional size of the recessed portions 14p, Dₚ, is smaller than the adjoining distance Dᵢₙₜ (Dₚ<Dᵢₙₜ).

The size of the microorganisms varies depending on their types. For example, the size of P. aeruginosa is about 1 μm. However, the size of the bacteria ranges from several hundreds of nanometers to about five micrometers. The size of fungi is not less than several micrometers. It is estimated that raised portions whose two-dimensional size is about 200 nm have a microbicidal activity on a microorganism whose size is not less than about 0.5 μm, but there is a probability that the raised portions are too large to exhibit a sufficient microbicidal activity on a bacterium whose size is several hundreds of nanometers. The size of viruses ranges from several tens of nanometers to several hundreds of nanometers, and many of them have a size of not more than 100 nm. Note that viruses do not have a cell membrane but have a protein shell called capsid which encloses virus nucleic acids. The viruses can be classified into those which have a membrane-like envelope outside the shell and those which do not have such an envelope. In the viruses which have an envelope, the envelope is mainly made of a lipid. Therefore, it is expected that the raised portions likewise act on the envelope. Examples of the viruses which have an envelope include influenza virus and Ebola virus. In the viruses which do not have an envelope, it is expected that the raised portions likewise act on this protein shell called capsid. When the raised portions include nitrogen element, the raised portions can have an increased affinity for a protein which is made of amino acids.

In view of the above, the configuration and production method of a synthetic polymer film having raised portions which can exhibit a microbicidal activity against a microorganism of not more than several hundreds of nanometers are described below.

In the following description, raised portions of the above-described synthetic polymer film which have a two-dimensional size in the range of more than 20 nm and less than 500 nm are referred to as “first raised portions”. Raised portions which are superimposedly formed over the first raised portions are referred to as “second raised portions”. The two-dimensional size of the second raised portions is smaller than the two-dimensional size of the first raised portions and does not exceed 100 nm. Note that when the two-dimensional size of the first raised portions is less than 100 nm, particularly less than 50 nm, it is not necessary to provide the second raised portions. Recessed portions of the mold corresponding to the first raised portions are referred to as “first recessed portions”, and recessed portions of the mold corresponding to the second raised portions are referred to as “second recessed portions”.

When the method of forming the first recessed portions which have predetermined size and shape by alternately performing the anodization step and the etching step as described above is applied without any modification, the second recessed portions cannot be formed successfully.

FIG. 4(a) shows a SEM image of a surface of an aluminum base (designated by reference numeral 12 in FIG. 2). FIG. 4(b) shows a SEM image of a surface of an aluminum film (designated by reference numeral 18 in FIG. 2). FIG. 4(c) shows a SEM image of a cross section of the aluminum film (designated by reference numeral 18 in FIG. 2). As seen from these SEM images, there are grains (crystal grains) at the surface of the aluminum base and the surface of the aluminum film. The grains of the aluminum film form unevenness at the surface of the aluminum film. This unevenness at the surface affects formation of the recessed portions in the anodization and therefore interrupts formation of second recessed portions whose Dₚ or Dᵢₙₜ is smaller than 100 nm.

In view of the above, a mold manufacturing method according to an embodiment of the present invention includes: (a) providing an aluminum base or an aluminum film deposited on a support; (b) the anodization step of applying a voltage at the first level while a surface of the aluminum base or aluminum film is kept in contact with an electrolytic solution, thereby forming a porous alumina layer which has the first recessed portions; (c) after step (b), the etching step of bringing the porous alumina layer into contact with an etching solution, thereby enlarging the first recessed portions; and (d) after step (c), applying a voltage at the second level that is lower than the first level while the porous alumina layer is kept in contact with an electrolytic solution, thereby forming the second recessed portions in the first recessed portions. For example, the first level is higher than 40 V, and the second level is equal to or lower than 20 V.

Specifically, an anodization step is carried out with the voltage at the first level, whereby the first recessed portions are formed which have such a size that is not influenced by the grains of the aluminum base or aluminum film. Thereafter, the thickness of the barrier layer is decreased by etching, and then, another anodization step is carried out with the voltage at the second level that is lower than the first level, whereby the second recessed portions are formed in the first recessed portions. When the second recessed portions are formed through such a procedure, the influence of the grains is avoided.

A mold which has first recessed portions 14pa and second recessed portions 14pb formed in the first recessed portions 14pa is described with reference to FIG. 5. FIG. 5(a) is a schematic plan view of a porous alumina layer of a mold. FIG. 5(b) is a schematic cross-sectional view of the porous alumina layer. FIG. 5(c) shows a SEM image of a prototype mold.

As shown in FIGS. 5(a) and 5(b), the surface of the mold of the present embodiment has the plurality of first recessed portions 14pa whose two-dimensional size is in the range of more than 20 nm and less than 500 nm and the plurality of second recessed portions 14pb which are superimposedly formed over the plurality of first recessed portions 14pa. The two-dimensional size of the plurality of second recessed portions 14pb is smaller than the two-dimensional size of the plurality of first recessed portions 14pa and does not exceed 100 nm. The height of the second recessed portions 14pb is, for example, more than 20 nm and not more than 100 nm. The second recessed portions 14pb preferably have a generally conical portion as do the first recessed portions 14pa.

The porous alumina layer shown in FIG. 5(c) was formed as described below.

The aluminum film used was an aluminum film which contains Ti at 1 mass %. The anodization solution used was an oxalic acid aqueous solution (concentration: 0.3 mass %, solution temperature: 10° C.). The etching solution used was a phosphoric acid aqueous solution (concentration: 10 mass %, solution temperature: 30° C.). After the anodization was carried out with a voltage of 80 V for 52 seconds, the etching was carried out for 25 minutes. Then, the anodization was carried out with a voltage of 80 V for 52 seconds, and the etching was carried out for 25 minutes. Thereafter, the anodization was carried out with a voltage of 20 V for 52 seconds, and the etching was carried out for 5 minutes. Further, the anodization was carried out with a voltage of 20 V for 52 seconds.

As seen from FIG. 5(c), the second recessed portions whose Dₚ was about 50 nm were formed in the first recessed portions whose Dₚ was about 200 nm. When in the above-described manufacturing method the voltage at the first level was changed from 80 V to 45 V for formation of the porous alumina layer, the second recessed portions whose Dₚ was about 50 nm were formed in the first recessed portions whose Dₚ was about 100 nm.

When a synthetic polymer film is produced using such a mold, the produced synthetic polymer film has raised portions whose configuration is the inverse of that of the first recessed portions 14pa and the second recessed portions 14pb shown in FIGS. 5(a) and 5(b). That is, the produced synthetic polymer film further includes a plurality of second raised portions superimposedly formed over a plurality of first raised portions.

The thus-produced synthetic polymer film which has the first raised portions and the second raised portions superimposedly formed over the first raised portions has a microbicidal activity on various microorganisms, ranging from relatively small microorganisms of about 100 nm to relatively large microorganisms of not less than 5 μm.

As a matter of course, only raised portions whose two-dimensional size is in the range of more than 20 nm and less than 100 nm may be formed according to the size of a target microorganism. The mold for formation of such raised portions can be manufactured, for example, as described below.

The anodization is carried out using a neutral salt aqueous solution (ammonium borate, ammonium citrate, etc.), such as an ammonium tartrate aqueous solution, or an organic acid which has a low ionic dissociation degree (maleic acid, malonic acid, phthalic acid, citric acid, tartaric acid, etc.) to form a barrier type anodized film. After the barrier type anodized film is removed by etching, the anodization is carried out with a predetermined voltage (the voltage at the second level described above), whereby recessed portions whose two-dimensional size is in the range of more than 20 nm and less than 100 nm can be formed.

For example, an aluminum film which contains Ti at 1 mass % is anodized at 100 V for 2 minutes using a tartaric acid aqueous solution (concentration: 0.1 mol/l, solution temperature: 23° C.), whereby a barrier type anodized film is formed. Thereafter, the etching is carried out for 25 minutes using a phosphoric acid aqueous solution (concentration: 10 mass %, solution temperature: 30° C.), whereby the barrier type anodized film is removed. Thereafter, the anodization and the etching are alternatively repeated as described above, specifically through 5 anodization cycles and 4 etching cycles. The anodization was carried out at 20 V for 52 seconds using an oxalic acid aqueous solution (concentration: 0.3 mass %, solution temperature: 10° C.) as the anodization solution. The etching was carried out for 5 minutes using the above-described etching solution. As a result, recessed portions whose two-dimensional size is about 50 nm can be uniformly formed.

Moth-eye molds which are capable of forming various moth-eye structures can be manufactured as described above.

Next, a method for producing a synthetic polymer film with the use of a moth-eye mold 100 is described with reference to FIG. 6. FIG. 6 is a schematic cross-sectional view for illustrating a method for producing a synthetic polymer film according to a roll-to-roll method.

First, a moth-eye mold 100 in the shape of a hollow cylinder is provided. Note that the moth-eye mold 100 in the shape of a hollow cylinder is manufactured according to, for example, the manufacturing method described with reference to FIG. 2.

As shown in FIG. 6, a base film 42 over which a UV-curable resin 34′ is applied on its surface is maintained pressed against the moth-eye mold 100, and the UV-curable resin 34′ is irradiated with ultraviolet (UV) light such that the UV-curable resin 34′ is cured. The UV-curable resin 34′ used may be, for example, an acrylic resin. The base film 42 may be, for example, a PET (polyethylene terephthalate) film or TAC (triacetyl cellulose) film. The base film 42 is fed from an unshown feeder roller, and thereafter, the UV-curable resin 34′ is applied over the surface of the base film 42 using, for example, a slit coater or the like. The base film 42 is supported by supporting rollers 46 and 48 as shown in FIG. 6. The supporting rollers 46 and 48 have rotation mechanisms for carrying the base film 42. The moth-eye mold 100 in the shape of a hollow cylinder is rotated at a rotation speed corresponding to the carrying speed of the base film 42 in a direction indicated by the arrow in FIG. 6.

Thereafter, the moth-eye mold 100 is separated from the base film 42, whereby a synthetic polymer film 34 to which the inverted moth-eye structure of the moth-eye mold 100 is transferred is formed on the surface of the base film 42. The base film 42 which has the synthetic polymer film 34 formed on the surface is wound up by an unshown winding roller.

The surface of the synthetic polymer film 34 has the moth-eye structure obtained by inverting the surficial nanostructures of the moth-eye mold 100. According to the surficial nanostructure of the moth-eye mold 100 used, the synthetic polymer films 34A and 34B shown in FIGS. 1(a) and 1(b), respectively, can be produced. The material that forms the synthetic polymer film 34 is not limited to the UV-curable resin but may be a photocurable resin which is curable by visible light or may be a thermosetting resin.

The microbicidal ability of a synthetic polymer film which has the moth-eye structure over its surface has not only a correlation with the physical structure of the synthetic polymer film but also a correlation with the chemical properties of the synthetic polymer film. For example, the present applicant found correlations with chemical properties, such as a correlation with the contact angle of the surface of the synthetic polymer film (Patent Publication 1: Japanese Patent No. 5788128) and a correlation with the concentration of the nitrogen element contained in the surface (International Application 2: PCT/JP2015/081608). As disclosed in International Application 2, the concentration of the nitrogen element at the surface is preferably not less than 0.7 at %. The entire disclosures of Patent Publication 1 and International Application 2 are incorporated by reference in this specification.

FIG. 7 shows SEM images disclosed in International Application 2 (FIG. 8). FIGS. 7(a) and 7(b) show SEM images obtained by SEM (Scanning Electron Microscope) observation of a P. aeruginosa bacterium which died at the surface which had the moth-eye structure shown in FIG. 1(a).

As seen from these SEM images, the tip end portions of the raised portions enter the cell wall (exine) of a P. aeruginosa bacterium. In FIGS. 7(a) and 7(b), the raised portions do not appear to break through the cell wall but appears to be taken into the cell wall. This might be explained by the mechanism suggested in the “Supplemental Information” section of Non-patent Document 1. That is, it is estimated that the exine (lipid bilayer) of the Gram-negative bacteria came close to the raised portions and deformed so that the lipid bilayer locally underwent a transition like a first-order phase transition (spontaneous reorientation) and openings were formed in portions close to the raised portions, and the raised portions entered these openings. Alternatively, it is estimated that the raised portions were taken in due to the cell's mechanism of taking a polar substance (including a nutrient source) into the cell (endocytosis).

The adhesion of microorganisms to various surfaces is explained by the Derjaguin-Landau-Verwey-Overbeek (DLVO) theory. The DLVO theory describes the interaction between particles as the sum of the electrical repulsion between the particles and the van der Waals attraction between the particles. The zeta potential plays an important role in the description of the electrical repulsion. In view of such, the present inventors examined the relationship between the zeta potential at the surfaces of various synthetic polymer films which have the moth-eye structure and the microbicidal ability of the synthetic polymer films and found that there is a correlation therebetween.

[Measurement of Zeta Potential]

In many cases, the zeta potential generally refers to the zeta potential of colloidal particles. Here, the zeta potential was measured at the surfaces of various synthetic polymer films which have the moth-eye structure (microbicidal surfaces) according to a method which will be described below. In measurement of the zeta potential, Zetasizer Nano series NanoZS (manufactured by Spectris) was used. The basic configuration of this system and the measurement method are disclosed in, for example, Japanese PCT National Phase Laid-Open Publication No. 2014-518379 (WO 2012/172330). The entire disclosure of Japanese PCT National Phase Laid-Open Publication No. 2014-518379 (WO 2012/172330) is incorporated by reference in this specification.

The configuration of a zeta potential measuring system 70 and the measurement method are briefly described with reference to FIG. 8 and FIG. 9. FIG. 8 is a schematic diagram showing the entire configuration of the zeta potential measuring system 70. FIG. 9 is a schematic diagram for illustrating the flow mechanism of tracer particles at a surface 72 of a sample 82.

The zeta potential measuring system 70 includes a light source 74, a sample cell 76 for holding a sample 82 which has a surface 72 that is to come into contact with an electrolytic solution 96 and that is subjected to measurement, and a detector 78. The inside of the sample cell 76 is filled with a liquid electrolyte 96 (also referred to as “electrolytic solution”) which contains charged tracer particles (not shown). The liquid electrolyte 96 that contains the tracer particles is a suspension. The tracer particles in the electrolytic solution 96 move according to an external electric field Ex applied between opposing electrodes 84 and 86. Here, the sample 82 is, for example, the film 50A shown in FIG. 1(a), which is arranged such that the surface 72 is the moth-eye surface of the synthetic polymer film 34A.

Light beam 75 emitted from the light source 74 is split by a half mirror Mo into two beams. One light beam is reflected by a reflective mirror M, and the reflected light beam (reference beam) 89 enters the detector 78. The other light beam (beam for measurement) 88 is diverted by other reflective mirrors M so as to enter the electrolytic solution 96. The tracer particles dispersed in the electrolytic solution 96 scatter the beam for measurement 88. Part of the scattered light 77 reaches the detector 78.

The phase of the scattered light 77 entering the detector 78 relative to the phase of the reference beam 89 is determined. The phase of the scattered light 77 is linearly related to the velocity of the tracer particles. The velocity of the tracer particles can be determined from the phase of the scattered light 77.

The x-y coordinates are set as shown in FIG. 9. The coordinates x are parallel to the surface 72 (boundary), while the coordinates y are vertical to the surface 72. It is assumed that when in the electrolytic solution 96 an external electric field Ex parallel to the surface 72 is applied, the slipping plane of the surface 72 coincides with the plane of y=0. The electric field Ex and the presence of ionic species in the electrolytic solution 96 cause electroosmotic fluid motion along the surface at y=0. Assuming that v (t, x, y) is the component of the fluid velocity which is parallel to the boundary, v depends on t (time) and the coordinates x and y. The surface 72 is moved parallel to the light beam 88 using an adjustment system such as a micrometer, and vi can be measured at a plurality of distances yi from the surface 72.

From the measurements vi (yi) at the plurality of different distances yi, vₑ₀ (=v (t, 0)) can be determined. The relationship between the surface zeta potential ζ and vₑ₀ is as follows:

vₑₒ/Eₓ=εζ/η (1)

where ε is the relative permittivity of the electrolytic solution 96, and η is the viscosity of the electrolytic solution 96.

As described above, the zeta potential at the surface 72 (surface zeta potential of the sample 82 can be measured using the system 70. The tracer particles used are negatively-charged tracer particles, for example, tracer particles which exhibit about −42 mV if without the influence from the surface 72. For example, polystyrene particles which are 350 nm in diameter exhibit a zeta potential of −42 mV in an aqueous electrolytic solution at 25° C.

[Synthetic Polymer Film]

Sample films No. 1 to No. 3 which have the same configuration as that of the film 50A shown in FIG. 1(a) were prepared. As the UV-curable resin for production of the synthetic polymer film 34A that has the moth-eye structure over its surface, resins A, B and C shown in Table 1 below were used. Table 1 shows the compositions of the respective resins (“%” in Table 1 represents mass %). Sample film No. 1 was produced using resin A. Sample film No. 2 was produced using resin B. Sample film No. 3 was produced using resin C. Each of resins A to C was dissolved into MEK (manufactured by Nissan Chemical Industries, Ltd.) to obtain a solution whose solid portion was 70 mass %. The resultant solution was applied onto a base film 42A, and the MEK was removed by heating, whereby a film having a thickness of about 20-30 μm was obtained. Note that the base film 42A used was a 75 μm thick PET film. Thereafter, a synthetic polymer film 34A that has the moth-eye structure over its surface was produced using the moth-eye mold 100A according to the same method as that described with reference to FIG. 6. In each of sample films No. 1 to No. 3, Dₚ was about 200 nm, Dᵢₙₜ was about 200 nm, and Dₕ was about 150 nm.

For the sake of comparison, sample films No. 4, No. 5 and No. 6 which did not have a moth-eye structure, i.e., which had a flat surface, were produced using resins A, B and C, respectively. [Chemical Formula 1] to [Chemical Formula 3] show the chemical structural formulae of the UV-curable resins (acrylate resins I, II and III). Acrylate resin I was a urethane acrylate resin and contains nitrogen element.

TABLE 1

| | Acrylate Resin I | Acrylate Resin II | Acrylate Resin III | Silicone Oil | Photoinitiator |
|---|---|---|---|---|---|
| | NK oligo UA-7100 | NK ester A-TMM-3LM-N | 4HBA | KF-353 | IRGACURE819 |
| | (manufactured by Shin- | (manufactured by Shin- | (manufactured by Shin- | (manufactured by Shin- | (manufactured by |
| | Nakamura Chemical Co., Ltd) | Nakamura Chemical Co., Ltd) | Nakamura Chemical Co., Ltd) | Etsu Chemical Co., Ltd.) | BASF) |
| Resin A | 99.29% | — | — | — | 0.71% |
| Resin B | — | 42.55% | 56.74% | — | 0.71% |
| Resin C | — | 42.25% | 56.34% | 0.70% | 0.70% |

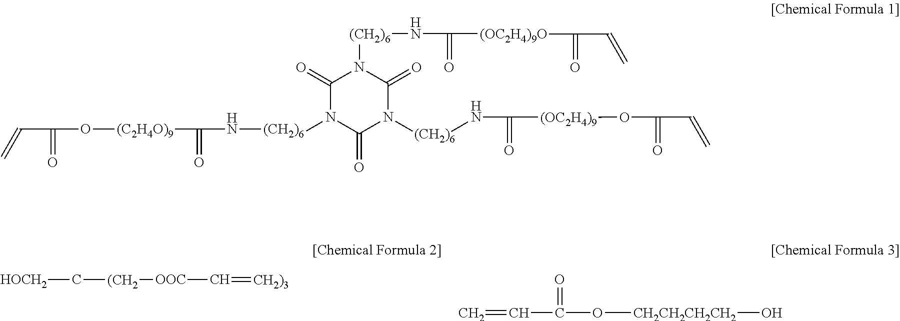

The results of measurement of the zeta potential of the respective sample films and the base film are shown in Table 2 below.

TABLE 2

| Sample No. | Zeta Potential (mV) |
|---|---|
| Sample Film No. 1 | −48.8 |
| Sample Film No. 2 | −40.5 |
| Sample Film No. 3 | −46.3 |
| Sample Film No. 4 | −41.9 |
| Sample Film No. 5 | −59.1 |
| Sample Film No. 6 | −74.8 |
| PET (base film) | −12 |

[Evaluation of Microbicidal Ability]

The microbicidal ability of sample films No. 1 to No. 3 was evaluated as follows:

1. Beads with frozen P. aeruginosa bacteria (purchased from National Institute of Technology and Evaluation) were immersed in a broth at 37° C. for 24 hours, whereby the P. aeruginosa bacteria were thawed and cultured;

2. Centrifugation (3000 rpm, 10 minutes);

3. The supernatant of the broth was removed;

4. Sterilized water was added, and the resultant solution was stirred and thereafter subjected to centrifugation again;

5. Steps 2 to 4 were repeated three times to obtain an undiluted bacterial solution (the bacteria count was of the order of 1E+07 CFU/mL);

6. 1/500 NB culture medium and bacterial dilution A (the bacteria count was of the order of 1E+05 CFU/mL) were prepared.

1/500 NB culture medium: NB culture medium (nutrient broth medium E-MC35 manufactured by Eiken Chemical Co., Ltd.) was diluted 500-fold with sterilized water.

Bacterial Dilution A: Undiluted Bacterial Solution 500 μL+Sterilized Water 49.5 mL;

7. Bacterial dilution B was prepared by adding the 1/500 NB culture medium as a nutrient source to bacterial dilution A (in accordance with JIS 22801 5.4a));

8. A 400 μL drop of bacterial dilution B (the bacteria count in the bacterial dilution B at this point in time is also referred to as “initial bacteria count”) was placed on each of the sample films. A cover (e.g., cover glass) was placed over the bacterial dilution B to adjust the amount of the bacterial dilution B per unit area.

Here, the initial bacteria count was 4.2E+05 CFU/mL;

9. The samples were left in an environment where the temperature was 37° C. and the relative humidity was 100% for a predetermined time period (time period: 3 hours or 20 hours);

10. The entire sample film with the bacterial dilution B and 9.6 mL sterilized water were put into a filter bag. The sample film was rubbed with hands over the filter bag to sufficiently wash away the bacteria from the sample film. The post-wash solution in the filter bag was a 25-fold dilution of the bacterial dilution B. This post-wash solution is also referred to as “bacterial dilution B2”. The bacteria count of the bacterial dilution B2 is to be of the order of 1E+04 CFU/mL if the bacteria count in the bacterial dilution B does not increase or decrease (time period: 0 hour);

11. The bacterial dilution B2 was diluted 10-fold, whereby bacterial dilution C was prepared. Specifically, the bacterial dilution C was prepared by putting 120 μL of the post-wash solution (bacterial dilution B2) into 1.08 mL sterilized water. The bacteria count of the bacterial dilution C is to be of the order of 1E+03 CFU/mL if the bacteria count in the bacterial dilution B does not increase or decrease;

12. The bacterial dilution C was diluted 10-fold in the same way as that for preparation of the bacterial dilution C, whereby bacterial dilution D was prepared. The bacteria count of the bacterial dilution D is to be of the order of 1E+02 CFU/mL if the bacteria count in the bacterial dilution B does not increase or decrease. Further the bacterial dilution D was diluted 10-fold, whereby bacterial dilution E was prepared. The bacteria count of the bacterial dilution E is to be of the order of 1E+01 CFU/mL if the bacteria count in the bacterial dilution B does not increase or decrease;

13. 1 mL drops of the bacterial dilution B2 and the bacterial dilutions C to E were placed on Petrifilm™ media (product name: Aerobic Count Plate (AC), manufactured by 3M). The bacteria were cultured at 37° C. with the relative humidity of 100%. After 48 hours, the number of bacteria in the bacterial dilution B2 was counted.

Note that, although in JIS 22801 5.6h) a phosphate-buffered saline is used in preparation of a diluted solution, sterilized water was used herein. It was verified that the microbicidal effect which is attributed to the physical structure and chemical properties of the surface of the sample films can be examined even when sterilized water is used.

FIG. 10 is a graph showing the evaluation results as to the microbicidal ability. In FIG. 10, the horizontal axis represents the time period for which the sample film was left (hour), and the vertical axis represents the bacteria count in bacterial dilution B2 (CFU/mL). Note that, in FIG. 10, when the bacteria count is 0, it is plotted as 1.0 for the sake of visibility.

As seen from FIG. 10, sample film No. 1 has excellent microbicidal ability, while sample film No. 2 does not have microbicidal ability. Sample film No. 3 that contains silicone oil has microbicidal ability, although not as much as that of sample film No. 1.

As seen from the zeta potentials shown in Table 2, the zeta potential of sample film No. 1 that had excellent microbicidal ability was −48.8 mV, which was the lowest (the absolute value was the largest). The zeta potential of sample film No. 3 that had microbicidal ability was −46.3 mV, which was an intermediate value. The zeta potential of sample film No. 2 that did not have microbicidal ability was −40.5 mV, which was the highest (the absolute value was the smallest). From these results, it is estimated that the microbicidal ability improves as the zeta potential decreases. It can be said that, at least when the zeta potential is not more than −46.3 mV, the film has microbicidal ability, and the microbicidal ability improves as the zeta potential decreases. Thus, it can be said that the zeta potential of the surface of the synthetic polymer film which has the moth-eye structure is preferably not more than −46.3 mV, more preferably not more than −48.8 mV.

Among sample films No. 4 to No. 6 that had a flat surface, the zeta potential of sample film No. 4 was the highest (the absolute value was the smallest), and the zeta potential of sample film No. 6 was the lowest (the absolute value was the largest). Considering from the viewpoint of the resin materials, the zeta potential of sample film No. 1 (−48.8 mV) which had excellent microbicidal ability was smaller than the zeta potential of sample film No. 4 (−41.9 mV) which had a flat surface and which was made of the same resin material A as that of sample film No. 1, and the absolute value of the zeta potential of sample film No. 1 was greater than that of sample film No. 4. It was only when resin A was used that the zeta potential was decreased by formation of the moth-eye structure. There is a probability that this contributes to the fact that sample film No. 1 has excellent microbicidal ability.

Resin A that was used for production of sample film No. 1 contains 2.2 at % nitrogen element, while resin C that was used for production of sample film No. 3 does not contain a nitrogen element. There is a probability that the reason why the microbicidal ability of sample film No. 1 is better than that of sample film No. 3 is attributed to the contained nitrogen element (International Application 2).

The reason why the microbicidal ability improves as the zeta potential decreases (as the absolute value of the zeta potential increases) is described below. Note that the following description is merely a consideration by the present inventors and does not intend to limit the present invention.

An adhesion mechanism of microorganisms is described in, for example, Hori et al., “Microbial Adhesion to Surfaces Mediated by Bacterial Nanofibers”, Journal of Environmental Biotechnology, Vol. 10, No. 1, 3-7, 2010. In this thesis, a two-phase adhesion mechanism is described with reference to FIG. 11 as in the following.

“Under the condition of a typical ionic strength, a shallow energy minimum occurs outside the energy barrier. The distance from the surface to this energy minimum varies depending on the ionic strength, although the distance is usually of the order of several nanometers. A bacteria cell comes to this position (the shallow energy minimum outside the energy barrier) by Brownian motion or by the motion of an organelle and reversibly adheres to the surface due to weak interaction with the surface. Then, EPS and/or bacterial adhesive nanofiber at the surface layer of the cell passes through the energy barrier and reaches a surface from which it cannot be distant due to the van der Waals attraction. The largeness of the energy barrier is proportional to the radius of a particle approaching an adsorption surface which can be assumed as a plate (which has a much greater radius of curvature than the bacteria). Therefore, in the case of an organelle or EPS which has a much smaller radius of curvature than the cell, no energy barrier is large enough to hinder it from passing across. This is what we mean by the previous expression ‘pass through’. Thus, of the bacteria, the major part of the cell remains at the shallow energy minimum outside the energy barrier, while the nanofiber and/or EPS bridges the gap of several nanometers between the cell and the surface, so that irreversible adhesion is achieved (two-phase adhesion mechanism) (FIG. 11).

Note that this mechanism applies only when the ionic strength is within a certain range. When the ionic strength is higher than this range, the energy barrier disappears. A bacteria approaching the surface achieves irreversible adhesion through one phase. When the ionic strength is lower than this range, the energy barrier is distant from the surface so that fiber or polymer cannot reach the surface, the shallow energy minimum disappears, and adhesion of the bacteria is prevented”.

As such, when the zeta potential of the surface is high, EPS and/or nanofiber, rather than the major part of the bacteria cell, adheres to the surface so that two-phase adhesion is achieved, resulting in stronger adhesion. As a result, it is estimated that the cell wall is closer to the raised portions of the moth-eye structure and is more strongly subjected to the microbicidal activity produced by the moth-eye structure.

A synthetic polymer film according to an embodiment of the present invention is suitably applicable to uses of suppressing generation of slime on a surface which is in contact with water, for example. For example, the synthetic polymer film is attached onto the inner walls of a water container for a humidifier or ice machine, whereby generation of slime on the inner walls of the container can be suppressed. The slime is attributed to a biofilm which is formed of extracellular polysaccharide (EPS) secreted from bacteria adhering to the inner walls and the like. Therefore, killing the bacteria adhering to the inner walls and the like enables suppression of generation of the slime.

As described above, bringing a liquid into contact with the surface of a synthetic polymer film according to an embodiment of the present invention enables sterilization of the liquid. Likewise, bringing a gas into contact with the surface of a synthetic polymer film according to an embodiment of the present invention enables sterilization of the gas. In general, microorganisms have such a surface structure that they can easy adhere to the surface of an object in order to increase the probability of contact with organic substances which will be their nutrients. Therefore, when a liquid or gas which contains microorganisms is brought into contact with a microbicidal surface of a synthetic polymer film according to an embodiment of the present invention, the microorganisms are likely to adhere to the surface of the synthetic polymer film, and therefore, on that occasion, the liquid or gas is subjected to the microbicidal activity.

Although the microbicidal activity of a synthetic polymer film according to an embodiment of the present invention against P. aeruginosa that is a Gram-negative bacteria has been described in this section, the synthetic polymer film has a microbicidal activity not only on Gram-negative bacteria but also on Gram-positive bacteria and other microorganisms. One of the characteristics of the Gram-negative bacteria resides in that they have a cell wall including an exine. The Gram-positive bacteria and other microorganisms (including ones that do not have a cell wall) have a cell membrane. The cell membrane is formed by a lipid bilayer as is the exine of the Gram-negative bacteria. Therefore, it is estimated that the interaction between the raised portions of the surface of the synthetic polymer film according to an embodiment of the present invention and the cell membrane is basically the same as the interaction between the raised portions and the exine.

### INDUSTRIAL APPLICABILITY

A synthetic polymer film which has a microbicidal surface according to an embodiment of the present invention is applicable to various uses including, for example, uses for sterilization of surfaces of kitchen and bathroom facilities. The synthetic polymer film which has a microbicidal surface according to an embodiment of the present invention can be produced at low cost.

### REFERENCE SIGNS LIST

34A, 34B synthetic polymer film
34Ap, 34Bp raised portion
42A, 42B base film
50A, 50B film
70 zeta potential measuring system
100, 100A, 100B moth-eye mold

1. A synthetic polymer film having a surface which has a plurality of first raised portions, wherein
a two-dimensional size of the plurality of first raised portions is in a range of more than 20 nm and less than 500 nm when viewed in a normal direction of the synthetic polymer film, the surface having a microbicidal effect, and
a zeta potential at the surface is not more than −46.3 mV.

2. The synthetic polymer film of claim 1, wherein the synthetic polymer film contains a nitrogen element.

3. The synthetic polymer film of claim 2, wherein a concentration of the nitrogen element at the surface is not less than 0.7 at %.

4. The synthetic polymer film of claim 1, further comprising a plurality of second raised portions superimposedly formed over the plurality of first raised portions,
wherein a two-dimensional size of the plurality second raised portions is smaller than the two-dimensional size of the plurality of first raised portions and does not exceed 100 nm.

5. The synthetic polymer film of claim 1, wherein a zeta potential at the surface is not more than −48.8 mV.
